(19) United States
(12) Patent Application Publication
(10) Pub. No.: US 2013/0325976 A1
(43) Pub. Date: Dec. 5, 2013

(54) TRANSFERRING ITEMS FROM ONE PARTY TO ANOTHER

(71) Applicants: Richard J.W. Mansfield, Cambridge, MA (US); Nissim Shani, Waban, MA (US); Daniel Shani, Waban, MA (US); Roni Shani, Waban, MA (US); Michele Shani, Waban, MA (US)

(72) Inventors: Richard J.W. Mansfield, Cambridge, MA (US); Nissim Shani, Waban, MA (US); Daniel Shani, Waban, MA (US); Roni Shani, Waban, MA (US); Michele Shani, Waban, MA (US)

(21) Appl. No.: 13/489,210

(22) Filed: Jun. 5, 2012

(51) Int. Cl. G06F 15/16

(52) U.S. Cl. 709/206; 709/217

(57) ABSTRACT

Among other things, a person who wants to give a tangible, physical, virtual, or digital item to another family member of a different generation (e.g., at a future time) can provide information from which the item, the future time, and the recipient can be determined. The giver and the recipient are individuals (a) who are not both living or not both competent at the time when the information is provided by the giver, (b) or may not both be living or may not both be competent at the future time, or (c) both (a) and (b), storing the information. The item is transferred to the other family member at the future time based on the provided information.

### BACKGROUND

This description relates to transferring items from one party to another.

A typical user of a social networking website communicates with other users of the social networking website by posting information about himself or information of interest to other users of the social network website in a manner that is accessible to the other users. For example, a user of a social networking website might post background information about himself, such as current job or activity information; information about events attended, such as concerts; events the user plans to attend, such as travel vacation sites; or personal events, such as birthdays or anniversaries. A user may also post information about recent acquisitions, such as the purchase of a new automobile or smartphone. Other users who have access to the user's posted information may contact the user to comment or review information about common shared interests or for other reasons.

Some social networking websites filter or group connections based on, e.g., friendship, profession or job type, or geographical location. Social networks often span users within a single generation (e.g., Generation X or Generation Y) or at least within a limited age demographic.

### SUMMARY

In general, in an aspect, information is maintained that has been provided by a donor about an item to be transferred, a recipient who is to receive the item, and a transfer time when the transfer item is to be transferred to the recipient. The information is maintained until the transfer time. A transfer of the item to the recipient is managed at the transfer time. The donor and the recipient are individuals who are not both living or not both competent at the time when the information is provided by the donor or at the transfer time or at both times.

Implementations may include one or more of the following features. The donor and the recipient are members of a family related by birth or marriage. The information is provided by the donor through an online facility. The online facility comprises a social networking facility. At least one of the donor and the recipient are members of an online facility that maintains the information. The information about the recipient does not identify a specific person. The information about the recipient comprises information that can be used at the transfer time to determine the specific recipient. The identity of the recipient is inferred at the transfer time. The identity is inferred analytically from the information or from other data or from both. The information about the transfer item identifies a specific item. The information about the transfer item comprises information that can be used at the transfer time to determine the specific transfer item. The transfer item is inferred analytically from the information or from other data. The information about the transfer time identifies a specific transfer time. The information about the transfer time identifies an event the occurrence of which is associated with the transfer time. The information about the transfer time comprises information that can be used to determine a specific transfer time. A specific transfer time is inferred from the information provided. The transfer item is stored on behalf of the donor until the transfer time. The storing comprises physical storage. The storing comprises digital storage. The transfer item exists at the time when the donor provides the information. The transfer item does not exist at the time when the donor provides the information. The transfer item comprises a memento, heirloom, or other item that has value in connection with a relationship of the donor and the recipient. The managing of the transfer comprises notifying the recipient of the transfer. The managing of the transfer comprises causing the transfer item to take a form intended by the donor. The recipient is confirmed to be related to the donor by birth or marriage. The transfer item comprises a tangible item. The transfer item comprises a virtual item. The transfer item comprises a digital item. The transfer item comprises an email, a voice recording, an image, a real-time photograph, or video. The donor and the recipient or people related to them can engage in social networking in connection with the maintaining of the information and the managing of the transfer. A user interface is exposed to the donor and the recipient for use with respect to the transfer. The user interface enables the donor to specify the transfer item and provide instructions about the transfer. The transfer time, the transfer item, or the transfer recipient or any combination of two or more of them, are inferred based on historical information about the donor or the recipient. The transfer time, the transfer item, or the transfer recipient or any combination of two or more of them, is based on inferred personal milestones or future needs or wants or affinities of the recipient. The donor and the recipient have a relationship that meets a relationship requirement. The donor can view profile and interest information associated with the recipient. If the donor is dead or incompetent, a content or style of communications to be had with the recipient is inferred on behalf of the donor. The donor is an agent of an institution or entity. A cost for the transfer item is prepaid. Managing the transfer comprises engaging vendors, distributors, and logistics operators to facilitate commerce related to the transfer item. Managing the transfer comprises maintaining a database of information about the transfer item, the donor, and the recipient. The database includes an inventory that identifies the transfer item. The database includes information about the status and location of the recipient. The transfer item comprises biological material and managing the transfer of the item comprises storing the biological material cryogenically. The transfer time comprises a future time. Information is provided online to the donor about people who may be potential recipients. Information is provided online to the donor about times that may be an appropriate transfer time. Information is provided online to the donor online about items that may be appropriate items to be transferred. The item is to be purchased online. The donor and the recipient are not members of a family related by birth or marriage. The donor comprises an institution or an entity and the recipient comprises a person currently or previously associated with the institution or entity.

In general, in an aspect, information is maintained that has been provided by a donor about a transfer item to be transferred, a recipient who is to receive the item, and a transfer time when the transfer item is to be transferred to the recipient. The time comprises a future time. The information is maintained until the transfer time. A transfer of the item to the recipient is managed at the transfer time. The donor and the recipient are individuals who have a specific relationship to one another that is the basis of the transfer, their specific relationship being authenticated before the transfer occurs. In some implementations, the specific relationship comprises a family relationship based on birth or marriage, and the time comprises a future time.

In general, in an aspect, a donor can provide through an interactive facility information about an item to be transferred, a recipient who is to receive the item, and a transfer time (e.g., a future time) when the transfer item is to be transferred to the recipient. The donor and the recipient are individuals (a) who are not both living or not both competent at the time when the information is provided by the donor, (b) or may not both be living or may not both be competent at the transfer time, or (c) both (a) and (b).

In general, in an aspect, a storage facility is operated in which physical items to be transferred to recipients at corresponding transfer times are stored. The transfer of the items to the recipients is managed at the transfer times in accordance with information provided by donors of the items about the items to be transferred, the recipients who are to receive them, and the transfer times in the future. Each of the donors and the corresponding recipients are individuals (a) who are not both living or not both competent at the time when the information is provided by the donor, (b) or may not both be living or may not both be competent at the transfer time, or (c) both (a) and (b).

In general, in an aspect, a storage facility is operated in which digital items to be communicated to recipients at corresponding transfer times in the future are stored. The transfer of the items to the recipients is managed at the transfer times in accordance with information provided by donors of the items about the items to be transferred, the recipients who are to receive them, and the transfer times in the future. Each of the donors and the corresponding recipients are individuals (a) who are not both living or not both competent at the time when the information is provided by the donor, (b) or may not both be living or may not both be competent at the transfer time, or (c) both (a) and (b).

In general, in an aspect, a social networking facility enables individuals who are related by birth or marriage to engage as a limited community in social networking activities that include communications, posting of information, and the transfer of items from donors in the community to recipients in the community based on information provided by the donors. Each of the donors and a corresponding recipient are individuals (a) who are not both living or not both competent at the time when the information is provided by the donor, (b) or may not both be living or may not both be competent at the transfer time, or (c) both (a) and (b).

In general, in an aspect, a donor user input module is configured to receive, from a donor user of a multigenerational social network, instructions to deliver at least one of a message and an item to a recipient user of the multigenerational social network. An analysis module is configured to select at least one of a delivery event, a delivery date, and an identity of the item based on data associated with the recipient user. A delivery module is configured to deliver, to the recipient user, at least one of the message, the item, and a message associated with the item according to at least one of the identified delivery event and the identified delivery date.

Implementations may include one or more of the following features. A storage module is configured to store the item. A storage database stores data associated with items stored in the storage module. A communications module is configured to determine at least one of a location and a status of the recipient user. The delivery module is configured to deliver according to at least one of the location and the status of the recipient user. The display module is configured to display a delivery instructions interface to the donor user and to display a representation of the delivery to the recipient user. The distribution database is configured to store data associated with at least one of item vendors, item distributors, and logistics of item delivery. The analysis module is configured to select an identity of the item based on data stored in the distribution database.

In general, in an aspect, a person who wants to give a tangible, physical, virtual, or digital item to another family member of a different generation at a future time can provide information from which the item, the future time, and the recipient can be determined. The giver and the recipient are individuals (a) who are not both living or not both competent at the time when the information is provided by the giver, (b) or may not both be living or may not both be competent at the future time, or (c) both (a) and (b). The information is stored. The item is transferred to the other family member at the future time based on the provided information.

In general, in an aspect, a computer-implemented method includes making a digital or physical memory box accessible to a person. By an electronic message, the person is encouraged to engage in an activity the result of which will be a digital or physical item. The recipient and the person have a relationship with respect to which the result of the activity will represent a memory for the recipient with respect to the person, the digital or physical memory box containing the result of the activity is received and stored. The recipient is given access to the digital or physical memory box at a future time (e.g., when the person is dead or incapacitated).

In general, in an aspect, people who have a relationship with one another can to participate in an online community of members, the members being controlled and limited based on the relationship. Transfer-initiating members can specify transfers of transfer items to be made at future transfer times to other members of the community. There is received from the transfer-initiating members, at initiation times, information from which the recipients of transfer items, the transfer items, and the transfer times can be determined. The transfer items are caused to be stored prior to the transfer times. The recipients, the transfer items, and the transfer times are selected to cause the recipients to have favorable memories about the initiating members associated with the relationships. Particular implementations can realize one or more of the following advantages. A multigenerational social network enables efficient and effective communication of messages and transfer of assets among members of a group, such as members of a family, a group of friends, members of a social or professional group, employees of a corporation, or another group of people. For instance, intergenerational communication and gift-giving may be facilitated through the use of a multigenerational social network. In some cases, a member of an older generation may wish to distribute assets such as heirloom furniture, family portraits, or mementos, but the intended recipient is unable or unwilling to receive such assets. The multigenerational social network provides systems for retaining such valuable assets until the intended recipient is able and willing to accept the transfer. Vendor contracts embedded within the multigenerational social network provide a wide range of potential gifts for transfer within the multigenerational social network. In addition, predictive analytics implemented by the multigenerational social network may help a donor user to identify an appropriate date or event and/or an appropriate gift for a particular recipient.

These and other aspects, features, implementations, and advantages, and combinations of them, can be expressed as methods, apparatus, systems, components, program products, business methods, and means or steps for performing functions, or combinations of them.

Other features, aspects, implementations, and advantages will become apparent from the description, the drawings, and the claims.

### DESCRIPTION

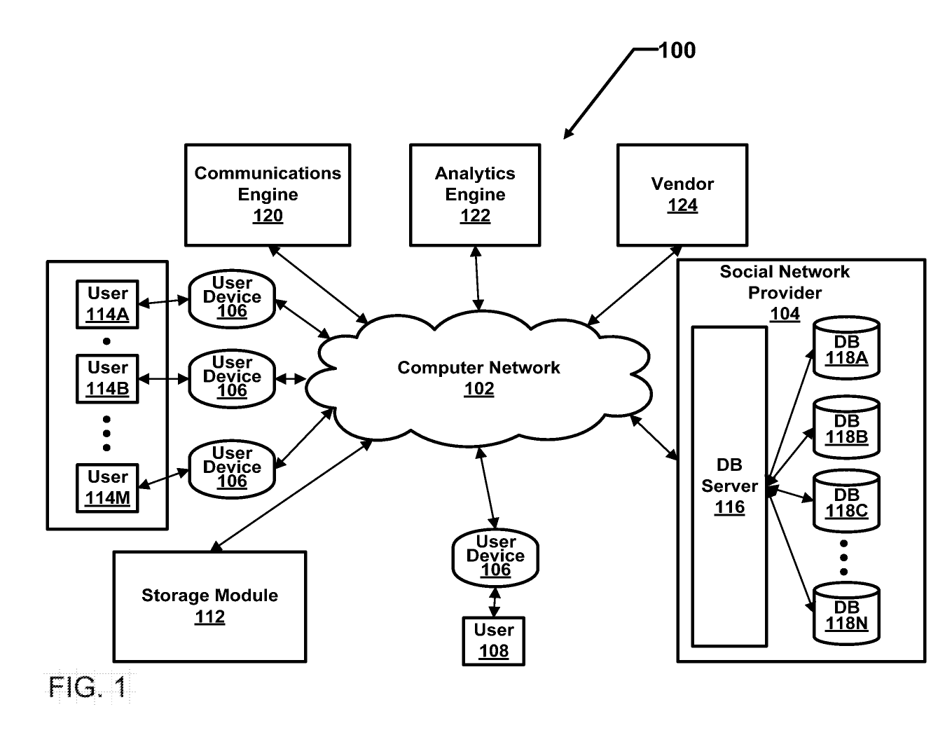

FIG. 1 is a block diagram of a multigenerational social network or other system.

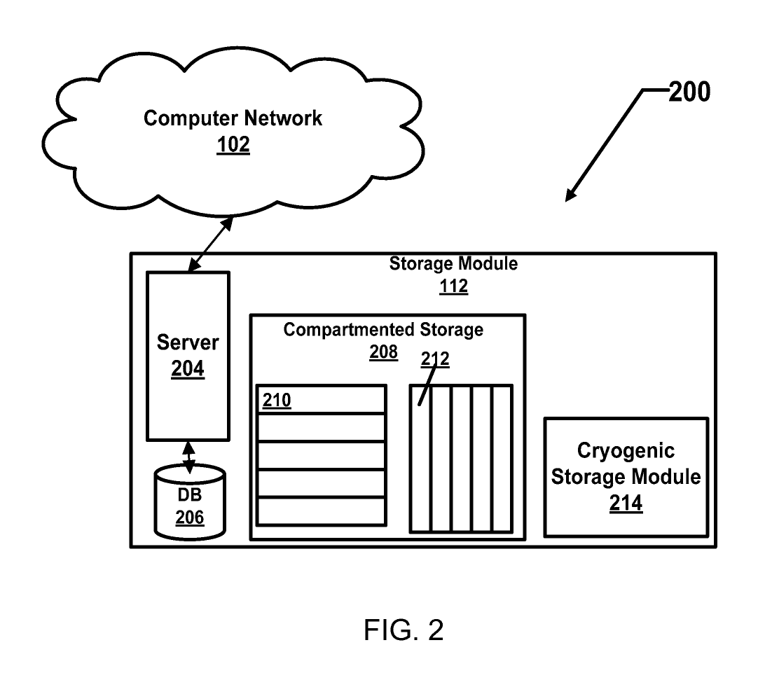

FIG. 2 is a block diagram of a storage module.

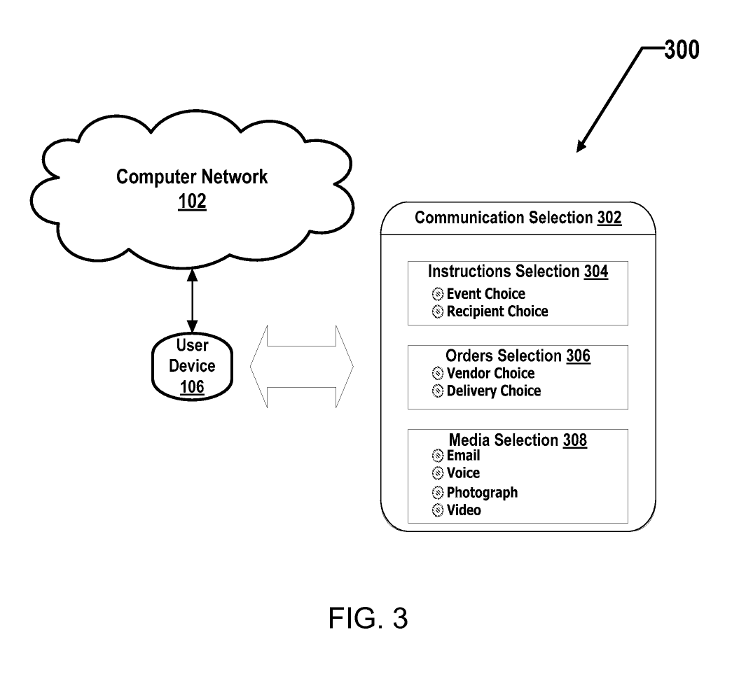

FIG. 3 is view of a user interface.

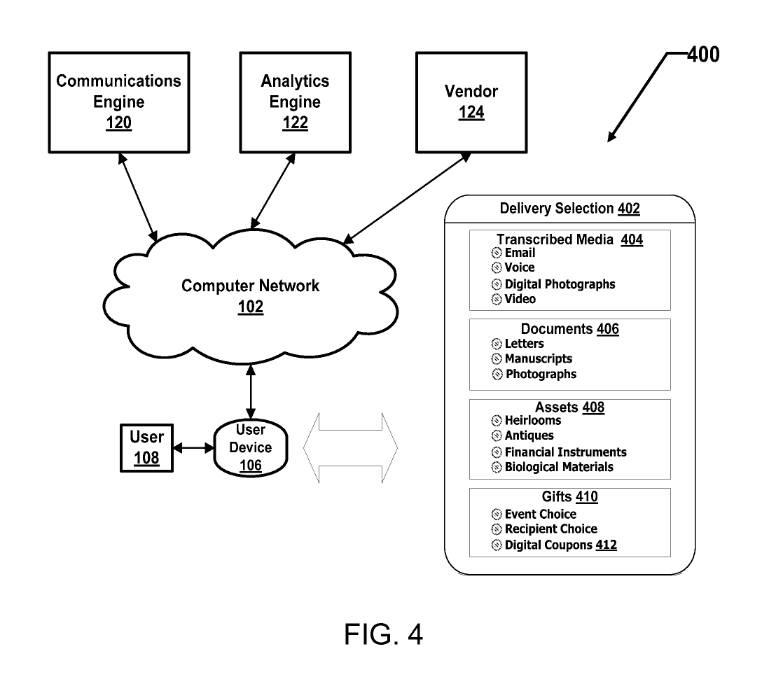

FIG. 4 is a view of a user interface.

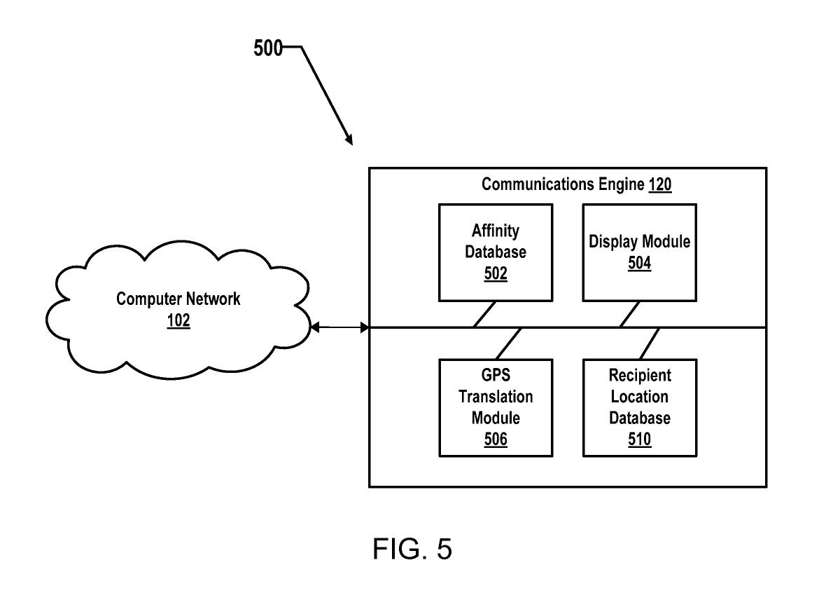

FIG. 5 is a block diagram of a communications engine.

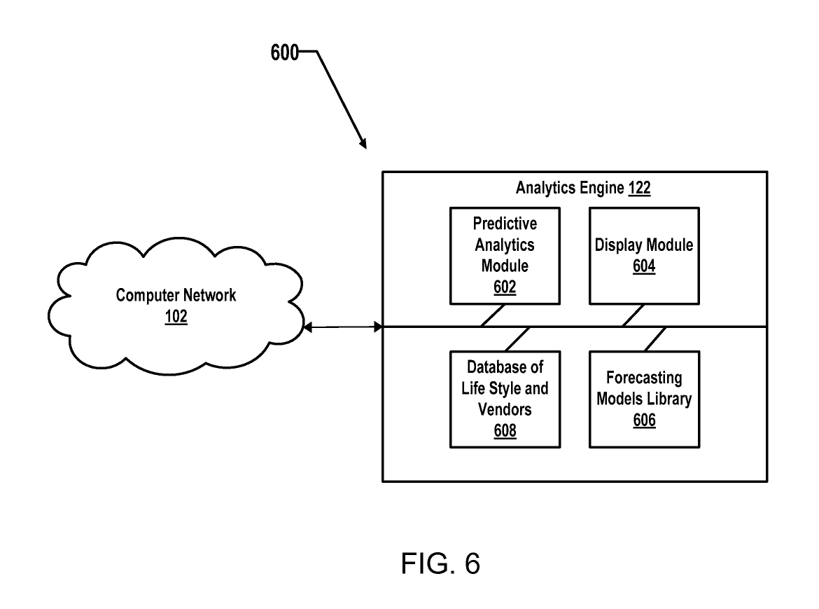

FIG. 6 is a block diagram of an analytics engine.

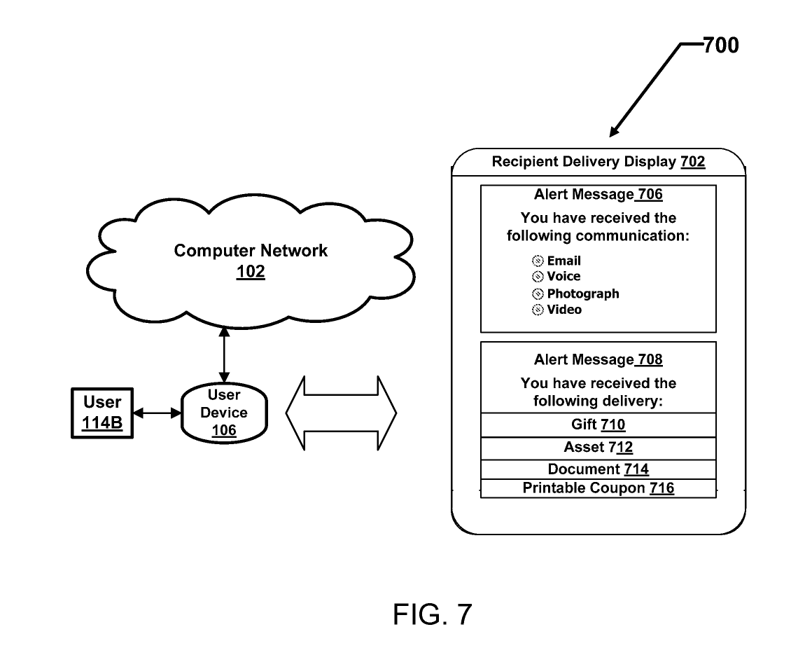

FIG. 7 is a view of a recipient display.

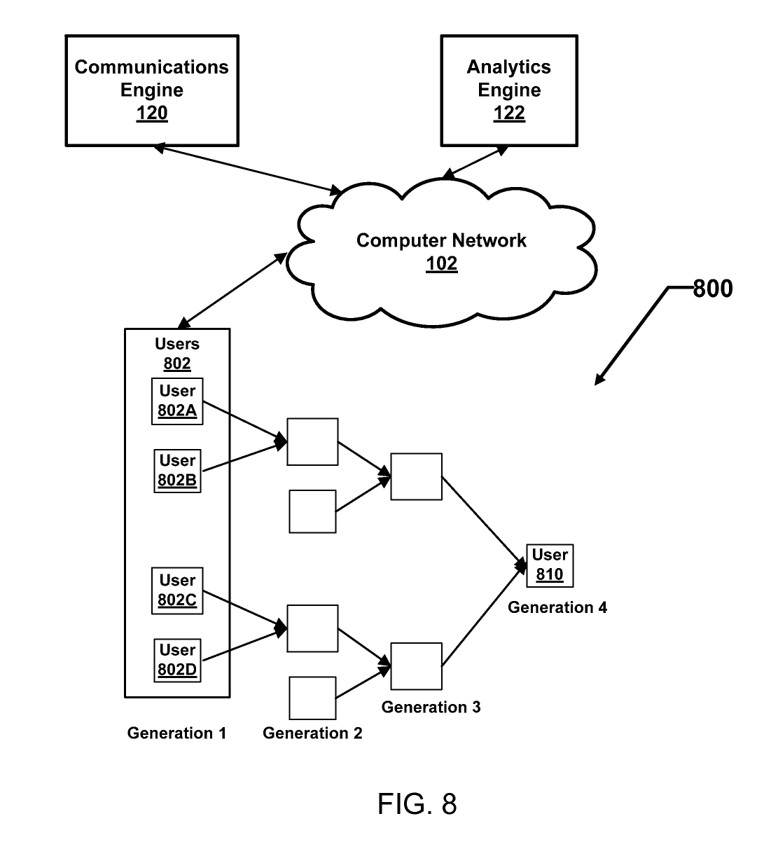

FIG. 8 is a block diagram a sequence of social commerce.

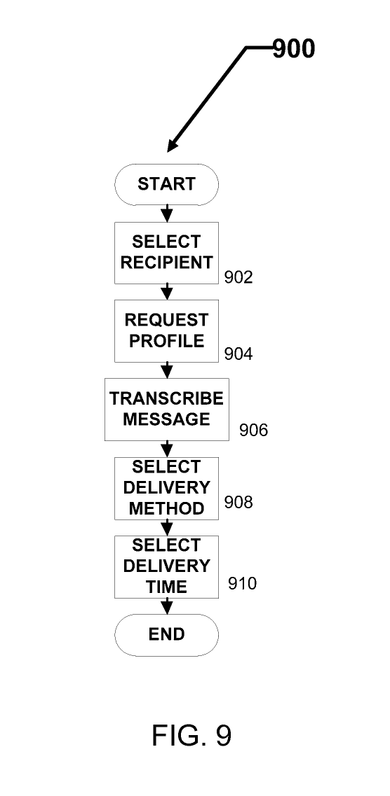

FIG. 9 is a flowchart of a process for communicating a message.

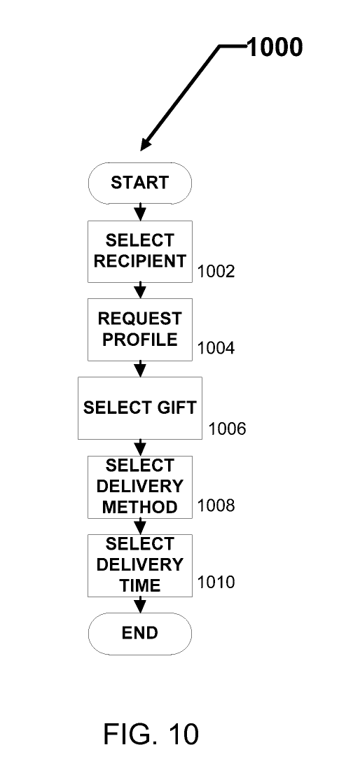

FIG. 10 is a flowchart of a process for transferring an item.

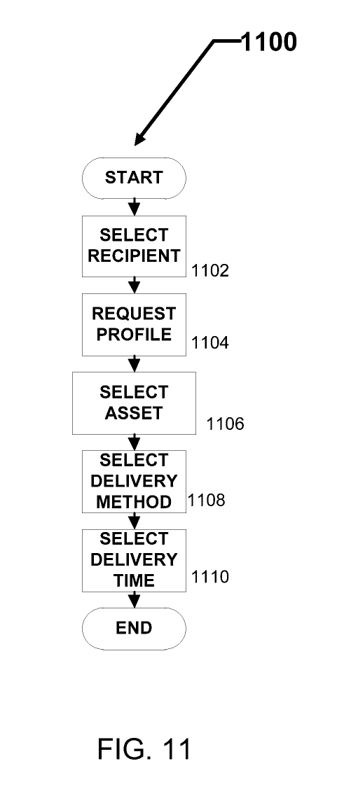

FIG. 11 is a flowchart of a process for transferring an item.

The system that we describe here enables members of a community of users of a network, for example, members of a community that includes multiple generations of an extended family, a group of friends, employees of a corporation, or any other group of people or entities known or unknown to each other, and combinations of any two or more of those, to cause items such as communications, goods, or services to be transferred to other members of the community, for example, at future times or in a way that is suggested by or associated with the relationship of the members or information about the members or both. Implementations of the system need not be limited to networks of the kind known as social networks and need not span multiple generations, but some implementations will be in the context of social networks or will be multi generational or both. For convenience, we sometimes refer to the system in some examples as a multigenerational social network, but we mean that phrase in a very broad sense to include, for example, any sort of network or grouping in which a community of users (we sometimes use the terms users and members interchangeably) participate, that includes members of a single generation or of multiple generations, or both features.

In some examples of the system, the community of users is a limited community that includes predominantly or solely members of a family group of users who are related by birth or marriage. In some cases, their relationship by birth or marriage has been authenticated. In some instances, people who are not related by birth or marriage but have a close relationship to the family (such as adopted children or a beloved friend or employee such as a nanny) can be included in the community as authenticated members. In some cases, the limited community can include a group of friends or acquaintances or other set of people who may have an interest in participating in the system. In some instances, the community can be any group of people whether known or unknown to one another.

We sometimes refer to the community as an authenticated community in a broad sense to mean, for example, that their entitlement to be members of the group can be established by records or vote or approval or in some other way. In some instances, however, it may be important that membership or entitlement in the community be provable by public records. For example, if a grandmother wants to be certain that transfers of communications or money from her to members of future generations of her family will go only to proven descendants related by blood, the system will verify or authenticate people as belonging to that group and manage the transfers to meet that requirement. Thus, membership in the community and qualification to receive a transfer can be defined in a variety of ways by the person who is doing the transfers and the system will manage the transfers accordingly to satisfy the intentions of the person doing the transfers. In some cases, the community can include users who fall into various categories, some authenticated to receive certain transfers, and others not.

An almost limitless variety of communications, goods, and services can be the subject of the transfers that we describe here, and we sometimes use the phrase “transfer item” to refer to the subjects of the transfers in the broadest possible sense.

In implementations of the system that we are describing, transfers of transfer items typically occur at a future time, which we sometimes call the transfer time. The time can be a specific day and even a specific time on a specific day, or can be defined less specifically as a period of time (for example, during the grandchild's 13^{th} year, or upon the marriage of the fourth great-grandchild). In most cases, the transfer time can either be named specifically in advance or conditions for determining the transfer time can be defined, or the transfer time can be determined later in various ways by the system itself or by the system with the help of others. The multigenerational social network system qualifies, enables, and manages the delivery of the transfer item at the transfer time. (The phrase multigenerational social network, which we use in this description, may suggest a system that is to be implemented on a social network platform and that requires participation by members of multiple generations of a family. In some examples that we discuss, that is the case. However, the system that we discuss here can be implemented in a wide variety of other ways as well, some of which do not involve multiple generations, members of a single family, or the use of a social network platform. When we use the phrase “multigenerational social network” it is not meant to be limited and is usually used interchangeably with the broad term system and to apply to all of the implementations and concepts encompassed in such a system.)

We sometimes refer to the person or entity that is, for example, arranging for or causing the transfer as a donor, in the broadest sense. And we sometimes refer to the recipient of a transfer as a recipient. In some cases, the donor or the recipient or both of them will be members of the community served by the network. However, the donor or recipient of a given transfer item need not have been or be a member of the network community. For example, a father who is a member of the community on the network may arrange for a transfer of brass candlesticks brought to the United States by his immigrant grandmother in 1901 to his not yet living great grandchildren who may never be members of the network.

In some cases, the transfer times for transfers are specified by the donor user. In some cases, a predictive analytics engine of the system, for example, in the multigenerational social network determines an appropriate delivery date to be used as the transfer time. The engine can base this determination, for example, on data associated with the recipient, predetermined criteria specified by the donor, or other information. In some instances, the transfer times can be determined by the multigenerational social network (the system).

In some examples, when the delivery date (we sometimes refer to the transfer time as the delivery date) occurs, the recipient user may be notified by the multigenerational social network (the system) and delivery can be arranged, if appropriate. In some cases, the notification may be given by a community member who participates in the network to someone who does not (for example, her four year old daughter).

In some instances, deliveries (we sometimes refer to transfers as deliveries) may be scheduled for holidays; anniversaries, such as birthdays; special occasions, such as bar mitzvahs or first communions; or milestone events, such as a high school or college graduation, the birth of a child, or a promotion or attainment of an achievement or award.

The form or context of the transfers made using the multigenerational social network may be gifts, inheritances, or other types of transfers. The transfer items can be an unlimited variety of communications, goods, or services, and other items.

Communications through the multigenerational social network may, for example, be or include verbal communications, such as text, handwriting, voice recordings, or other types of digital speech; photographs, such as physical photographs or digital images; video communications; or communications in other media without limit.

In some cases, the transfer items in the form of goods or services may be digital, such as an image or a text message (e.g., a short message service (SMS) message or an email) containing, e.g. a prepaid coupon or information related to a bank account number and access instructions. The transfer items may be virtual, such as an icon or an asset for an online game (e.g. a Zynga FarmVille™ animal). The transfer items may include an arrangement with a vendor for delivery of a pre-purchased gift or service. The goods that are the transfer items can be physical or tangible. In some instances, the multigenerational social network provides physical storage facilities for physical or tangible transfer items, such as heirlooms, mementos, letters, documents, cryogenically stored biological materials, or other physical goods. The physical storage facility can provide services involved in maintaining, restoring, or preserving goods. Transfer items can be combinations of and two or more of communications, goods, or services, and any two or more of physical, virtual, or digital items. For example, a transfer item can be an heirloom watch combined with a digital message referring to the watch and a digital photograph of the donor wearing the watch.

In some cases, the donor user specifies the transfer item, for example, the exact content of a message or a type of asset (e.g., gift) to be transferred. In some cases, the predictive analytics engine determines an appropriate message or type of asset based on data associated with the recipient user or predetermined criteria specified by the donor user or by the multigenerational social network.

In some embodiments, the multigenerational social network provides notification of changes in information associated with users of the multigenerational social network. The notifications may be frequent or automatic or both. Such automatic notifications may enable communications or asset distributions to be triggered or timed by specific events. For instance, a donor user may indicate that balloons are to be delivered to a recipient user on the recipient user's birthday without specifying the particular day (e.g., on the 21^{st} birthday of a recipient user who is currently two years old). Alternatively, a donor user may indicate that flowers are to be delivered to a recipient user upon the death or incapacitation of the donor user (e.g., automatic delivery of wedding anniversary flowers for ten years after the donor user's death).

Thus, the donor is able to specify the transfer items, the transfer times, and the transfer recipients either specifically or by criteria that can be used to determine the specific items, times, and recipients. In some implementations, an engine, for example, an analytics engine, can participate in the determinations. In some cases, people other than the donor can have a role. For example, the recipient may be allowed to make a choice as among several possible transfer items. Or a parent of the recipient may be authorized to participate in the determination of when a child will receive a transfer item and which item will be transferred.

The system can be implemented in a very wide variety of ways as a network in which some or all of the members of the limited community (we sometimes use the terms limited community and community interchangeably) are participants.

FIG. 1 is a block diagram of an example of the system, e.g., a multigenerational social network 100 for transferring items, e.g., communicating messages (e.g., media messages) and distributing gifts, physical or digital assets, and mementos, among members of a community that participates, for example, in the multigenerational social network. In this example, a computer network 102 connects a social network provider 104 (such as Facebook or Google+) with the user devices 106 such as workstations, mobile devices, mobile computers, for communicating across the computer network 102. In some examples, the social network provider can be the operator or host of the system in addition to or instead of an existing social network provider. A donor user 108 can create, write, dictate, preform, copy, define, or otherwise transcribe media messages, enter instructions about transfer items, criteria, recipients, and transfer times, for example; give orders to the vendors 124 and give orders to the storage modules 112 regarding documents, media communications (we sometimes use the terms communications and media communications interchangeably), goods, and services and other transfer items for delivery to the recipient users 114 (114A, 114B, . . . , 114M). A communications engine 120 facilitates identification of the location, status, and interest profile (e.g., affinities) of intended recipient users 114 that can be accessed by an authenticated donor user 108. For example, a grandmother may learn about the school activities of one of her grandchildren. An analytics engine 122 using information from various databases facilitates the determination for a donor user 108 of an appropriate gift, physical or digital asset, or other transfer item and its delivery at the appropriate transfer time to intended recipient users, 114. In some examples, the social network provider 104 supplies a database server 116 to the computer network 102. The database server has one or more databases 118 [118A, 118B, . . . 118N], for storing a wide variety of information useful for or related to the operation of the system, including user instructions, orders, and media messages as well as the profile and historical data of socially networked individuals together with information on vendors and distributors and the logistics involved in facilitating intergenerational social commerce.

FIG. 2 is a block diagram of a physical storage module 112 for a multigenerational social network or system 100. The storage module 112 provides a secure facility for storage of physical or tangible transfer items, such as digital media, documents, gifts, assets, and mementos and a wide variety of other physical or tangible items, for social commerce and other transfer from one member of a community to another, for example, across the multigenerational social network. A database server 204 in the storage module 112, connected to the computer network 102, stores a wide variety of information including information associated with inventory, transaction history, status, and scheduled delivery dates for transfer items stored in the storage module 112. A database server 204 stores digital media in a database 206, including, in some cases, scanned versions of physical documents and objects stored in the storage module for backup should reconstruction of those documents or objects become necessary. The information on the server may be replicated to an offsite server for backup redundancy.

Within the secure facility provided by the storage module 112 there are climate-controlled compartmented storage rooms 208 for storing collectibles such as artwork or heirloom furniture. Acid-free archive compartments, 210 can be used to store paper, fabrics and small mementos. In some cases and for certain purposes, the archive compartments can serve as what we call memory boxes. Larger objects such as statues may be stored in protective crates 212. The storage facility may include specialized storage facilities for the storage of a diverse array of assets. For instance, a storage facility may be provided to store and/or synthesize odors, such as the scent of a favorite perfume. An example storage facility includes automated climate control, e.g., at non-freezing temperatures; radio frequency identification (RFID) labeling of stored items; robotic assisted retrieval of stored items (e.g., such as the robotic assisted retrieval used by amazon.com in its distribution warehouses); and authenticated access control and access tracking. As another example, flash-frozen food such as baked goods or biological material such as cryogenically frozen sperm, eggs, embryos, or stem cells from baby teeth can be stored in a cryogenic storage module 214, such as a cryogenic bio-repository. An example cryogenic bio-repository is the Angelatoni Industries Automated Freezers/Smartfreezer® Series with nominal working temperature down to −180° C., humidity control to eliminate icing, fully automated retrieval of stored items by a robotic arm, sample identification by two-dimensional and linear barcode readers, and built-in matching between inventory data and physical sample location with authenticated access control and access tracking. In some examples, the storage module can be arranged to store, preserve, and deliver any possible kind of tangible, physical, or digital manifestation of a transfer item.

The storage module 112 may provide storage for physical memory boxes or digital memory boxes or both, for instance in the archive compartments 210 or the database 206. Memory boxes enable users, including children and adults, to store “memories,” or records of their thoughts, plans, expectations, or other ideas. The contents of a memory boxes may be maintained indefinitely until a user requests retrieval of some or all of the contents of the memory box, or may be delivered to the user or to another recipient at a specified time (e.g., a time specified upon creation of the memory box or upon deposit of a particular item into the memory box). Memory boxes may also be used for the storage of messages, such as birthday or anniversary greetings, that a user wishes to have delivered to a recipient at a later date.

A physical memory box may be used to store, for instance, drawings, essays, journal entries, or other written material. In some cases, the user may be provided with a prompt to prepare material for storage in the physical memory box. For instance, a different subject may be provided regularly, such as monthly, as a prompt to the user. Example subjects may include questions about what the user hopes or expects to see or experience in the future (e.g., what the user hopes to accomplish within the next year); questions about the user's personal thoughts (e.g., what are the user's favorite things, which ethnic or religious groups does the user identify with), questions about current events (e.g., the user's opinion about a current election or political controversy); questions about the user's daily life (e.g., a description of “a day in the life” of the user); or other prompts. The subjects may be provided uniformly to all users who maintain a physical memory box, or the subjects may be tailored to each user or to a subgroup of users (e.g., children may receive different prompts than adults). A physical memory box may also include a recorder, such as a digital voice recorder, to record conversations, which may be related to any topic, including in response to the previously mentioned prompts.

A digital memory box may include scanned versions of materials included in a physical memory box (e.g., scanned copies of a child's drawings) and/or may include material created specifically for the digital memory box. For instance, a user may record a conversation and email or upload the conversation to a server of the multigenerational social network, which then causes the conversation to be stored in the user's digital memory box. In some embodiments, the multigenerational social network may provide a phone number that a user can dial to have a conversation recorded and stored directly in the user's digital memory box. The phone number may be a general phone number such that the user enters an identification code in order to access his account; or the phone number may be a phone number specific to the user. When the user dials the phone number, he may be presented with a prompt, such as the example prompts listed above; or he may be given the opportunity to record an open-ended conversation. The user may be prompted to dial the phone number, e.g., by an email message, a short message service (SMS) message, or a phone call. In some cases, the user may be prompted to select what to do with the recording, such as when and to whom to release the recording. A memory box is a type of transfer item and can be subjected to instructions of the donor user about the recipient, the transfer time, and other information that will control the use of the memory box.

FIG. 3 is an example donor communication interface 300 of a multigenerational social network (a system. The user device 106 displays a donor communication interface 300, which provides a communication selection window 302 allowing a donor user to input instructions 304 and orders 306, e.g., related to a communication or delivery of a transfer item. The donor communication interface 300 is also operable to transcribe media messages, 308, which may be in the form of e-mail, voice, images, scanned or real-time photographs, or video.

Example media messages include birthday greetings, congratulations on graduation, celebration of an anniversary, or holiday greetings. Other example media messages include videos of the birth of a baby, a toddler's first steps, or a child's first day at a school. For a multigenerational social network (system) in which the donor user is an agent of a corporation or an institution such as a school, a city, state or federal government, an example video media message may be an event or “day in the life of” the organization for future reference or dissemination to viewers of interest. In some examples, a media message may include last words or a more extensive message from a donor user to his survivors, such as the donor user's children, including the donor user's autobiography to be delivered in full or released in stages.

FIG. 4 illustrates an example of a donor user's delivery or other transfer selection interface 400 of a multigenerational social network. The user device 106 displays a donor delivery selection interface 400, which provides a delivery selection window 402 allowing a donor user to select a type of communication or asset for delivery within a multigenerational social network or other system, including, e.g., transcribed media 404, documents 406, assets 408, and gifts 410, including digital coupons 412 from a vendor 124 and any combination of two or more of them. The donor user is prompted to select a recipient user and optionally to select an event associated with the delivery of the communication or asset (e.g., flowers to be delivered on an anniversary) or other transfer of a transfer item. The delivery selection interface 400 allows the donor user to select a preferred vendor and method of delivery, where appropriate. Once the donor user has entered the appropriate information, a communication engine 120 of the multigenerational social network determines the location, status, or affinities or any combination of two or more of them of the recipient user. In some cases, the analytics engine 122 is employed to assist the donor user in selecting a delivery date (e.g., by using historical data to forecast personal milestones of a recipient user), an appropriate asset or transfer item for delivery (e.g., by forecasting future needs and wants of a recipient user), or delivery times (transfer times) best suited for the recipient user, or any combination of two or more of them, among other things.

FIG. 5 is a block diagram of a communications engine 120 of a multigenerational social network or other system 100. The communication engine 120 facilitates intergenerational commerce (transfers of transfer items) for a donor user 108 by providing access to the physical location, profile interest information, or affinity information or any combination of them pertaining to one or more recipient users 114. In some examples, the location, interest, and affinity information may be displayed by a display module 504 on a webpage belonging to the donor user. The communication engine 120 also displays the recipient user's location profile within the multigenerational social network 100. The communication engine 120 includes a recipient affinity database 502 for storing recipient user affinity information and a recipient location database 510 for storing the physical location of a recipient user. The recipient location database 510 may receive data relevant to the location of a recipient user from a GPS translation module 506.

FIG. 6 is a block diagram of an analytics engine 122 of the multigenerational social network or other system 100. The analytics engine 122 facilitates intergenerational commerce for donor user 108 by determining or inferring milestone events for the recipient user 114 or determining or inferring an appropriate gift or asset (transfer item) for a recipient user or both among other things. A predictive analytics module 602 applies forecasting models stored in a forecasting models library 606 to analyze present and/or historical recipient user data in view of data stored in a database 608 containing data related to vendor profiles and lifestyle information to identify milestone events and to suggest appropriate gifts for a recipient user. The predictive analytics module 602 implements a variety of forecasting techniques beyond simple algorithms, such as future date calculation, including statistical techniques such as machine learning (e.g., as applied by IBM's Watson computer), game theory, and data mining, to analyze current and historical data to make predictions about future recipients, to identify appropriate document, asset or gift selections, and to identify appropriate delivery times and methods, among a wide variety of other analyses and algorithms. For instance, historical data representative of purchases made by a recipient user may be modeled against data representative of categories of purchased items to identify potential gifts for the recipient user. Analytics engine 122 may use data specific to a user to identify potential milestone events (e.g. to identify a bar mitzvah date for a child based on the child's birth date or to identify appropriate religious holidays based on the user's specified religious affiliation or a prevailing religion in the region where the user lives). In some cases, the predictive analytics module 602 may also incorporate present or historical donor user data or both to identify relevant recipient user milestone events or gifts or both that are in keeping with preferences of the donor user.

A display module 604 of the analytics engine 122 may display the milestone events of a recipient user on a webpage belonging to a donor user. In some embodiments, the analytics engine 122 may automatically communicate notices of an event relevant to a recipient user, such as a birthday, to communications module 120, which sends the notices to relatives of the recipient user. The analytics engine may use information about a recipient user found in various databases to determine when to send out the notices. In some embodiments, the predictive analytics incorporate the robust, optimizing forecasting techniques of Pinto et al. (U.S. Pat. No. 7,499,897, issued on Mar. 3, 2009; U.S. Pat. No. 7,562,058, issued on Jul. 14, 2009; U.S. Pat. No. 7,725,300, issued on May 25, 2010; U.S. Pat. No. 7,730,003, issued on Jun. 1, 2010; U.S. Pat. No. 7,933,762, issued on Apr. 26, 2011; and U.S. patent application Ser. No. 10/826,949, filed Apr. 16, 2004, the contents of all of which are incorporated herein by reference), that manage historical data using missing values, which must be inferred.

In some embodiments, the analytics engine acts as a surrogate of a donor user 108 to generate responses (e.g., messages, gift selections, and/or delivery instructions) based on historical data specific to the recipient user. For instance, the analytics engine may be configured as described by Gruber et al. (U.S. patent application Ser. No. 12/987,982, filed Jan. 10, 2011, the contents of which are incorporated herein by reference) to include an automated assistant receiving user input; an active ontology with representations of concepts and relations among concepts drawn from various databases of historical data (for instance, for the case in which the donor user is the agent of a corporation, the corporate personnel database may be referenced); and a language interpreter parsing the donor user input to derive a representation of donor user intent in terms of the active ontology together with a services orchestration to output responses and instructions to implement the donor user's intent.

FIG. 7 is an example recipient display interface 700. A recipient delivery display 702 indicates the arrival of a communication or delivery of a transfer item. A communication alert window 706 indicates that recipient user 114B has received the delivery of a communication. A delivery alert window 708 indicates that recipient user 114B has received the delivery of a gift 710, an asset 712, a document 714, or a printable digital coupon 716. For a communication, after the donor user 108 has transcribed a media message and provided instructions for its delivery to a recipient user 114B, the instructions are stored in an order database along with the transcribed message until a prescribed event occurs or other conditions are met for delivery of the message. An alert message is then displayed to the recipient user 114B in the communication alert window 706 along with an icon (which may be the alert message) which, when activated (e.g., clicked), delivers the transcribed message. A similar process occurs in the case of a gift 710 or an asset 712, particularly when the gift or asset is a vendor coupon that is printable, with the alert message and icon (which may be the alert message) displaying in delivery alert window 708. If the gift or asset is in physical storage (e.g., in the storage module 200) or is to be provided by a vendor, then the alert message displayed in delivery alert window 708 indicates the availability of the gift or asset. The recipient user 114B is given the opportunity to arrange for delivery from the storage facility, for example by a common carrier such as FEDEX, UPS, DHL, or the USPS. Alternatively, the recipient user is put into contact with the vendor of the physical or digital item to arrange for delivery.

FIG. 8 is a block diagram of an example sequence 800 of intergenerational social commerce (including transfers of transfer items by a system) across a family tree facilitated by a multigenerational social network (the system). A registered user 802D belonging to a first generation (802A, . . . , 802H) has composed (transcribed) a digital media message and selected a gift to be delivered on the 21^{st} birthday of a potential recipient user 810 in the third succeeding generation. Assuming the donor user 802D meets one or more criteria that indicate a relationship with the potential recipient user 810 the donor user 802D is given access to the profile of the recipient user 810. Upon receiving an inquiry from a donor user 802D to view the multigenerational social network 100 in which the recipient user 810 has a profile, the donor user 802D is provided access to the available information or the projected information about recipient user 810 inferred by the analytics engine. The analytics engine can act as a surrogate for the donor user 802D by specifying communications, goods, and services or any other transfer items for placement into storage. Provided the potential recipient user 810 is registered on the multigenerational social network, the communication engine 120 will determine the location of the recipient user, e.g. by GPS tracking or similar means. The recipient user's interests and status may be available in the recipient user's profile, which, taken together with historical data, enable the analytics engine 122 utilizing inferences from missing data, if necessary, to determine an appropriate gift to accompany the message and an optimal time for delivery. The delivery time is selected by a predictive analytics algorithm, based on historical data specific to the recipient user.

In the example of FIG. 8, the recipient user is the projected offspring of a current member in the multigenerational social network and the donor user is incapacitated at the time of delivery. By a computer-implemented method, data relevant to the recipient user may be extracted from his profile and/or generated implicitly based, at least in part, on the recipient user's stored profile together with historical data by a predictive analytics algorithm based on historical data. Based on the extracted or generated data a gift is selected, in some cases without input from the donor user.

FIG. 9 is a flowchart of an example process 900 for communicating a multimedia message in a multigenerational social network. In the process 900, a donor user 108 selects a recipient user 114D or a potential recipient user in the multigenerational social network (step 902). For an existing recipient user within the relationship group, the donor user 108 requests the recipient user's profile that includes biographical details, location, and interests which are retrieved by the communication engine 120 (step 904). If the recipient user has not yet activated or become a member of the multigenerational social network, the analytics engine 122 infers the probable profile, location, and interests subject to later adjustment. The donor user 108 then transcribes a multimedia message (step 906), which might be in the form of an email and confirms, through review, that the communication message is correct. The donor user 108 then designates a delivery method, date, and time; or rules or criteria or both for determination of the delivery method and date (steps 908 and 910), in some cases with the help of the analytics engine 122. Upon confirmation by the donor user, the transcribed communication is stored pending delivery. At the specified future delivery time or at a time determined by the analytics engine 122 the transcribed communication is retrieved from storage and delivered in the manner specified. The recipient user can acknowledge receipt and confirm delivery and even reply to the donor user 108 or to his proxy.

FIG. 10 is a flowchart of an example process 1000 for distributing a gift (more generally, for transferring a transfer item) in a multigenerational social network (or other system). In the process 1000, a donor user 108 selects a recipient user 114D or potential recipient user in the multigenerational social network (step 1002). For an existing recipient user within the relationship group or community, the donor user 108 requests the recipient user's profile consisting of biographical details, location, and interests which are retrieved by the communication engine, 120 (step 1004). If the recipient user has not yet activated the multigenerational social network, the analytics engine 122 infers the probable profile, location, and interests subject to later adjustment. The donor user 108 then selects a gift (step 1006), which might be physically stored in the secure facility 200 or available from a vendor in the form of a pre-paid coupon for some good or service, and confirms, through review, that the selected gift is correct. The donor user 108 then designates a delivery method, date, and time; or rules and/or criteria for determination of the delivery method and the date (steps 1008 and 1010), in some cases with the help of the analytics engine 122. Upon confirmation of the correctness of the foregoing by the donor user, the transcribed communication is stored pending its delivery. At the specified future delivery time, or the time determined by the analytics engine 122 (the transfer time) the selected gift is retrieved from storage or ordered from a vendor and delivered in the manner specified. The recipient user can acknowledge receipt and confirm delivery and can even reply to the donor user 108 or can reply to the donor user's proxy.

FIG. 11 is a flowchart of an example process 1100 for distributing an asset in a multigenerational social network environment. In the process 1100, a donor user 108 selects a recipient user 114D or a potential recipient user in the multigenerational social network (step 1102). For an existing recipient user within the relationship group the donor user 108 requests the recipient user's profile consisting of biographical details, location, and interests which are retrieved by the communication engine 120 (step 1104). If the recipient user has not yet activated or become a member of the multigenerational social network, the analytics engine 122 infers the probable profile, location, and interests subject to later adjustment. The donor user 108 then selects an asset (step 1106), which might be physically stored in the secure facility 200 or available from a vendor, and confirms, through review, that the selected asset is correct. The donor user 108 then designates a delivery method, date, and time; or rules and/or criteria for determination of the delivery method and the date (steps 1108 and 1110), in some cases with the help of the analytics engine 122. Upon confirmation by the donor user 108, the transcribed communication is stored pending its delivery. At the specified future delivery time, or the time determined by the analytics engine 122 the selected asset 1102 is retrieved from storage or ordered from a vendor and delivered in the manner specified. The recipient user can acknowledge receipt and confirm delivery and even reply to the donor user 108 or to the proxy of the donor user.

In some embodiments, the donor user 108 is an agent of a corporation or other entity who sends an asset or transfers a transfer item to current or past employees in good standing, e.g., stock options, or, more personally an award or achievement plaque. In some embodiments, the analytics engine acts as a surrogate of a donor user 108 in which the analytics engine is configured to generate an asset selection. In the case where the analytics engine acts as a surrogate for a donor user who is an agent of a corporation, the analytics engine would use the corporate personnel database to determine the recipient users and based on their profiles determine the appropriate asset or transfer item to select, e.g., stock option, achievement award or other valuable consideration.

In some instances, the multigenerational social network is a social network of family members. The donor user may be a member of an older generation and the recipient user may be a member of a younger generation. In some cases, the intended recipient user is not yet a member of the multigenerational social network, either because the recipient user has not yet enrolled or because the recipient user has not yet been born. In some cases, the donor user may be incapacitated or even dead at the time of delivery (e.g., the donor user may be an incapacitated or dead grandparent of the recipient user). If the donor user is incapacitated or dead, the multigenerational social network may carry out the instructions of the donor user and request confirmation as appropriate from a designated proxy of the donor user, such as a parent of the recipient user or an executor of the donor user's estate. In some cases, the multigenerational social network requests confirmation of the identity and/or role of the designated proxy. For instance, if the executor of the donor user's estate logs into the multigenerational social network using the deceased donor user's credentials, the executor may be considered to have been authenticated as the donor user's proxy.

In some instances, the donor user is an institution or other entity or an agent of such an institution or other entity, such as a school or a city, state, or federal government; or a company, or a trust or foundation, or a non-profit organization, for example. The recipient user may be a current employee in good standing or a past employee, e.g., a retiree or someone who was terminated or resigned. For a variety of reasons the institution or entity may find it useful to maintain a relationship with the employee and to transfer items at transfer times to the employee to maintain the relationship.

For instance, the donor user may use a multigenerational social network or other system to send a message to the recipient user, such as a holiday greeting, a message of congratulations on a promotion, a greeting card for a birthday or other anniversary, a reminder of a spouse's or child's birthday, or a suggested message to be forwarded to the spouse or child. Deliveries may include a gift card for a holiday, birthday, or award; stock options; an achievement plaque; or another award. In some cases, the analytics engine may act as a surrogate for the donor user and may use the corporate personnel database to identify recipient users and, based on the profiles of the recipient users, determine appropriate milestones and/or gifts. For instance, an analytics engine customized to a particular company may track the addresses, email addresses, or other contact information of past employees to enable the company to maintain relationships with the past employees. In other examples, the multigenerational social network may provide an employee feedback portal for a company, in which employees of the company (acting as donor users) submit suggestions, complaints, or comments, which are then forwarded, singly or in aggregate, to the human resources department (acting as the recipient user) of the company.

In other instances, the multigenerational social network is used by a group of people, such as a group of friends, acquaintances, coworkers, or another group of people. For instance, a friend may act as a donor and arrange for the delivery of a birthday gift to another friend through the multigenerational social network or other system.

In some instances, the multigenerational social network enables the transfer of items from a donor user to a recipient, who may not necessarily be a member of the social network, through a proxy recipient user who is a member of the social network. For example, a grandfather may use the multigenerational social network to set up the delivery of a chemistry set to his two-year-old granddaughter on her tenth birthday. The grandfather dies before the granddaughter turns ten. When the granddaughter does reach her tenth birthday, she is too young to join the social network. The analytics module is able to determine the transfer item (the chemistry set), the delivery location (e.g., the granddaughter's parents' house), and the delivery (transfer) date (the granddaughter's tenth birthday), but is unable to send a delivery message to the granddaughter directly because she is not a member of the multigenerational social network. The analytics module can identify the granddaughter's parents as proxies for the granddaughter and send the delivery message to the parents. For instance, the parents may be automatically considered the proxy of the recipient or may be asked to provide authentication of their relationship with the recipient prior to being considered the proxy of the recipient. In some cases, the parents, as proxy for the recipient, may be asked to approve the relationship between the recipient and the donor user and/or the appropriateness of the transfer item.

In some examples of the use of proxies, a corporate human resources department may want to send flowers to the wife of a current or retired employee, but the wife is not a member of the multigenerational social network (in the context of an entity or institution and individuals related to the entity or institution, the phrase multigenerational social network may be thought of as a communication system between the entity or institution through its proxy and the individuals; we call such a system a multigenerational social network for convenience even though it may not be multigenerational and may not use a social network for its operation. The analytics module determines that the wife works at another company and identifies that she has kept her maiden name. However, a message cannot be sent to the wife directly over the multigenerational social network, and furthermore the wife cannot be directly authenticated. The multigenerational social network thus identifies her husband (i.e., the current or former employee of the company) as a proxy for the wife and sends the delivery message and/or the delivery of flowers to the husband, who can then deliver the flowers to his wife.

In some instances of the use of the system, the donor user may be the same person as the recipient user, but from an earlier point in time. For example, a donor user may specify that a video expressing his political opinions, aspirations, or conceptions for a future spouse is to be delivered to himself twenty years in the future. In other instances, a recipient user may receive a purported message from a donor user's dog or cat. In other instances, a recipient user may receive a notification from a benefactor donor user, e.g., a dead relative, to retrieve memorabilia, gifts, or other assets from a storage module.

The adoption of social networks by commercial vendors and non-profit organizations provides an opportunity to extend the range of assets or transfer items than can be transferred. For instance, a prepaid coupon to a coffee shop, a just-in-time delivery of flowers for Valentine's Day, or a donation to a charitable organization by a deceased donor user's estate may all be effected by the multigenerational social network or other system.

As desired, the multigenerational social network may include more or fewer than the components illustrated.

The multigenerational social network is described above with reference to block and flow diagrams of systems, methods, apparatuses, and/or computer program products according to examples. In some instances, the donor and recipient users may access the social network by desktop or laptop computers. In some embodiments, the donor and recipient users may access the social network by mobile devices such as smart phones. In some embodiments, the donor and recipient users may access the social network by tablet computers or any commercial computing device connected to the internet. In some cases, the social network may be constructed to operate on the internet independent of existing social networks. The multigenerational social network may operate using existing social networks, e.g., Facebook, as platforms using existing application interfaces open to website developers.

One or more blocks of the block diagrams and flow diagrams, and combinations of blocks in the block diagrams and flow diagrams, respectively, can be implemented by computer-executable program instructions. Some blocks of the block diagrams and flow diagrams may not necessarily need to be performed in the order presented, or may not necessarily need to be performed at all, in some cases.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special purpose hardware and computer instructions.

While the multigenerational social network has been described in connection with certain examples, is the system is not limited to the disclosed embodiments, but on the contrary, includes various modifications and equivalent arrangements. Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g. a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products. Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

Other implementations are also within the scope of the following claims.

1. A computer-implemented method comprising:
maintaining, by a computer, information provided by a donor about a transfer item to be transferred, a recipient who is to receive the transfer item, and a transfer time when the transfer item is to be transferred to the recipient, the information being maintained until the transfer time,
inferring, by a computer, one or more of (a) the transfer item, based on the information provided by the donor if the information does not explicitly identify the transfer item, (b) an identity of the recipient, based on the information provided by the donor if the information does not explicitly identify the recipient, and (c) the transfer time, based on the information provided by the donor and information about the recipient if the information does not explicitly identify the transfer time, and
managing, by a computer, a transfer of the transfer item to the recipient at the transfer time.

2. The method of claim 1 in which the donor and the recipient are related by birth or marriage.

3. The method of claim 1 in which the information is provided by the donor through an online facility.

4. The method of claim 1 in which at least one of the donor and the recipient are members of an online facility that maintains the information.

5. The method of claim 4 in which the online facility comprises a social networking facility.

6. The method of claim 1 in which the information about the recipient does not identify a specific person.

7. The method of claim 1 in which the information about the recipient comprises information that can be used at the transfer time to determine the specific recipient.

8. The method of claim 1 in which inferring the identity of the recipient includes inferring the identity of the recipient at the transfer time.

9. The method of claim 8 in which the identity is inferred analytically from the information or from other data or from both.

10. The method of claim 1 in which the information about the transfer item identifies a specific item.

11. The method of claim 1 in which the information about the transfer item comprises information that can be used at the transfer time to determine the specific transfer item.

12. (canceled)

13. The method of claim 1 in which the information about the transfer time identifies a specific transfer time.

14. The method of claim 1 in which the information about the transfer time identifies an event the occurrence of which is associated with the transfer time.

15. The method of claim 1 in which the information about the transfer time comprises information that can be used to determine a specific transfer time.

16. (canceled)

17. The method of claim 1 comprising storing the transfer item on behalf of the donor until the transfer time.

18. The method of claim 17 in which the storing comprises physical storage.

19. The method of claim 17 in which the storing comprises digital storage.

20. The method of claim 1 in which the transfer item exists at the time when the donor provides the information.

21. The method of claim 1 in which the transfer item does not exist at the time when the donor provides the information.

22. The method of claim 1 in which the transfer item comprises a memento, heirloom, or other item that has value in connection with a relationship of the donor and the recipient.

23. The method of claim 1 in which the managing of the transfer comprises notifying the recipient of the transfer.

24. The method of claim 1 in which the managing of the transfer comprises causing the transfer item to take a form intended by the donor.

25. The method of claim 1 comprising confirming that the recipient is related to the donor by birth or marriage.

26. The method of claim 1 in which the transfer item comprises a tangible item.

27. The method of claim 1 in which the transfer item comprises a virtual item.

28. The method of claim 1 in which the transfer item comprises a digital item.

29. The method of claim 1 in which the transfer item comprises an email, a voice recording, an image, a real-time photograph, or video.

30. The method of claim 1 comprising enabling the donor and the recipient or people related to them to in social networking in connection with the maintaining of the information and the managing of the transfer.

31. The method of claim 1 comprising exposing a user interface to the donor for use with respect to the transfer.

32. The method of claim 31 in which the user interface enables the donor to specify the transfer item and provide instructions about the transfer.

33. The method of claim 1 in which the transfer time, the transfer item, or the transfer recipient or any combination of two or more of them, is inferred based on historical information about the donor or the recipient.

34. The method of claim 1 in which the transfer time, the transfer item, or the transfer recipient or any combination of two or more of them, is inferred based on personal milestones or future needs or wants or affinities of the recipient.

35. The method of claim 1 in which the donor and the recipient have a relationship that meets a relationship requirement.

36. The method of claim 35 comprising enabling the donor to view profile and interest information associated with the recipient.

37. The method of claim 1 comprising, when the donor is dead or incompetent, inferring a content or style of communications to be had with the recipient on behalf of the donor.

38. The method of claim 1 in which the donor comprises an agent of an institution or entity.

39. The method of claim 1 in which a cost for the transfer item is prepaid.

40. The method of claim 1 in which managing the transfer comprises engaging vendors, distributors, and logistics operators to facilitate commerce related to the transfer item.

41. The method of claim 1 in which managing the transfer comprises maintaining a database of information about the transfer item, the donor, and the recipient.

42. The method of claim 41 in which the database includes an inventory that identifies the transfer item.

43. The method of claim 41 in which the database includes information about the status and location of the recipient.

44. The method of claim 1 in which the transfer item comprises biological material and managing the transfer of the item comprises storing the biological material cryogenically.

45. A computer-implemented method comprising:
maintaining, by a computer, information provided by a donor about a transfer item to be transferred and a recipient who is to receive the transfer item,
inferring, by a computer, one or more of (a) the transfer item, based on the information provided by the donor if the information does not explicitly identify the transfer item, and (b) an identity of the recipient, based on the information provided by the donor if the information does not explicitly identify the recipient and
managing, by a computer, a transfer of the transfer item to the recipient,
the donor and the recipient being individuals who have a specific relationship to one another that is the basis of the transfer and is in addition to their relationship as donor and recipient, their specific relationship being authenticated before the transfer occurs.

46. The method of claim 45 in which the specific relationship comprises a family relationship based on birth or marriage.

47. The method of claim 45 in which the transfer item is transferred at a future time.

48. The method of claim 45 comprising providing the donor online information about people who may be potential recipients.

49. The method of claim 45 comprising providing the donor online information about times that may be an appropriate for the transfer.

50. The method of claim 45 comprising providing the donor online information about items that may be appropriate items to be transferred.

51. The method of claim 45 in which the item is to be purchased online.

52. The method of claim 45 in which the donor and the recipient are not members of a family related by birth or marriage.

53. The method of claim 45 in which the donor comprises an institution or an entity and the recipient comprises a person currently or previously associated with the institution or entity.

54. A computer-implemented method comprising
enabling a donor to provide through an interactive facility information about an item to be transferred, a recipient who is to receive the item, and a transfer time when the transfer item is to be transferred to the recipient, the donor and the recipient being individuals (a) who are not both living or not both competent at the time when the information is provided by the donor, (b) or may not both be living or may not both be competent at the transfer time, or (c) both (a) and (b).

55. The method of claim 54 in which the time comprises a future time.

56. A method comprising
managing, by a computer, operation of a storage facility in which physical items to be transferred from donors to corresponding recipients at corresponding future transfer times are stored,
storing the physical items in the storage facility in accordance with instructions of the donors, and
managing, by a computer, the transfer of the items to the recipients at the transfer times in accordance with information provided by the donors about the items to be transferred, the recipients who are to receive them, and the transfer times in the future,
(a) each of the donors and each of the corresponding recipients being individuals who may not both be living or may not both be competent at the transfer time, (b) the recipients being individuals who may not be living or competent at the time when the information is provided by the donor, or (c) both (a) and (b).

57. A method comprising
operating, by a computer, a storage facility in which digital items to be communicated from donors to corresponding recipients at corresponding transfer times in the future are stored,
inferring, by a computer, for a donor, one or more of (a) an identity of the corresponding recipient, based on the information provided, if the information does not explicitly identify the recipient, and (b) the corresponding transfer time, based on the information provided by the donor and information about the recipient if the information does not explicitly identify the transfer time, and
managing, by a computer, the transfer of the items to the recipients at the transfer times in accordance with information provided by donors of the items about the items to be transferred, the recipients who are to receive them, and the transfer times in the future.

58. A computer-implemented method comprising
hosting a social networking facility that enables individuals who are related by birth or marriage to engage as a limited community in social networking activities that include communications, posting of information, and in the transfer of items from donors in the community to recipients in the community based on information provided by the donors, each of the donors and a corresponding recipient being individuals (a) who are not both living or not both competent at the time when the information is provided by the donor, (b) or may not both be living or may not both be competent at the transfer time, or (c) both (a) and (b).

59. A system comprising:
a donor user input module configured to receive, from a donor user of a multigenerational social network, instructions to deliver at least one of a message and an item to a recipient user of the multigenerational social network;
an analysis module configured to select at least one of a delivery event, a delivery date, and an identity of the item based on data associated with the recipient user, and
a delivery module configured to deliver, to the recipient user, at least one of the message, the item, and a message associated with the item according to at least one of the identified delivery event and the identified delivery date.

60. The system of claim 59 comprising a storage module configured to store the item.

61. The system of claim 59 comprising a storage database for storing data associated with items stored in the storage module.

62. The system of claim 59 comprising a communications module configured to determine at least one of a location and a status of the recipient user.

63. The system of claim 59 in which the delivery module is configured to deliver according to at least one of the location and the status of the recipient user

64. The system of claim 59 comprising a display module configured to display a delivery instructions interface to the donor user and to display a representation of the delivery to the recipient user.

65. The system of claim 59 comprising a distribution database configured to store data associated with at least one of item vendors, item distributors, and logistics of item delivery.

66. The system of claim 59 in which the analysis module is configured to select an identity of the item based on data stored in the distribution database.

67. A method comprising:
enabling a person who wants to give a tangible, physical, virtual, or digital item to another family member of a different generation at a future time, to provide information from which the item, the future time, and the recipient can be determined, the giver and the recipient being individuals (a) who are not both living or not both competent at the time when the information is provided by the giver, (b) or may not both be living or may not both be competent at the future time, or (c) both (a) and (b),
storing the information, and
transferring the item to the other family member at the future time based on the provided information.

68. A computer-implemented method comprising
making a digital or physical memory box accessible to a person,
by an electronic message, encouraging the person to engage in an activity the result of which will be a digital or physical item, the recipient and the person having a relationship with respect to which the result of the activity will represent a memory for the recipient with respect to the person,
receiving and storing the digital or physical memory box containing the result of the activity, and
giving the recipient access to the digital or physical memory box at a future time.

69. The method of claim 68 in which the future time is a time when the person is dead or incapacitated.

70. A computer-implemented method comprising
enabling people who have a relationship with one another to participate in an online community of members, the members being controlled and limited based on the relationship,
enabling transfer-initiating members to specify transfers of transfer items to be made at future transfer times to other members of the community,
receiving from the transfer-initiating members, at initiation times, information from which the recipients of transfer items, the transfer items, and the transfer times can be determined,
causing the transfer items to be stored prior to the transfer times.
the recipients, the transfer items, and the transfer times being selected to cause the recipients to have favorable memories about the initiating members associated with the relationships.

71. A computer-implemented method comprising
maintaining, by a computer, information provided by a donor about a transfer item to be transferred, a recipient who is to receive the item, and a transfer time when the transfer item is to be transferred to the recipient, the information being maintained until the transfer time, and
managing, by a computer, a transfer of the transfer item to the recipient at the transfer time,
the recipient being an individual who is not living or not competent at the transfer time, the time when the information is provided by the donor, or both.
